(19) United States
(12) Patent Application Publication
(10) Pub. No.: US 2007/0056043 A1
(43) Pub. Date: Mar. 8, 2007

(54) Remote cell phone auto destruct

(76) Inventors: Richard Onyon, San Jose, CA (US); Liam Stannard, San Jose, CA (US); Leighton Ridgard, San Jose, CA (US)

Correspondence Address: VIERRA MAGEN MARCUS & DENIRO LLP, 575 MARKET STREET SUITE 2500, SAN FRANCISCO, CA, 94105, US

(21) Appl. No.: 11/437,793

(22) Filed: May 19, 2006

Related U.S. Application Data
(60) Provisional application No. 60/682,951, filed on May 19, 2005.

(51) Int. Cl. H04N 7/16

(52) U.S. Cl. 726/26

(57) ABSTRACT

Technology to secure personal information stored on a wireless device after the device is lost or stolen by encrypting or destroying the information is provided. A method for securing a mobile device having an information store includes the steps of providing a mobile device application on a mobile device; and signaling the mobile application instructing the mobile application to render any user information stored on the mobile device useless.

This application claims priority to U.S. Provisional Application No. 60/682,951 filed May 19, 2005, entitled “Remote Cell Phone Auto Destruct,” which is incorporated herein by reference.

### BACKGROUND OF THE INVENTION

Description of the Related Art

Wireless telephones have become more powerful with the inclusion of such features as cameras, address books, calendars and games. Many now include microprocessors, operating systems and memory which allow developers to provide limited applications for the phones. Phones now include the ability to play multimedia files including polyphonic ringtones, MP3 files, MPEG, AVI and QuickTime movies, and the like, in addition to displaying pictures taken on or downloaded to the phone.

Wireless phones have long been able to access the Internet via a Wireless Access Protocol (WAP) browser, and receive messages via SMS. A user on a wireless telephone connects via the wireless network to a server which enables the phone to read WAP enabled content. Most providers enable a user to access an email message account via the WAP browser, and/or provide short message service (SMS) messages directly to the user's phone. SMS allows users to receive abbreviated text messaging directly on the phone. Messages can actually be stored on the phone, but the storage available is limited to a very small amount of memory. In addition, no provision for handling attachments in SMS is available.

More recently, phones themselves have become powerful enough to utilize data connections over a carrier's network to manipulate data. For example, users of a carrier's network can download multimedia content to their phone, shop and download phone specific applications, and send and receive more robust messaging. Devices which have been combined with wireless phones, such as Research In Motion's Blackberry device, provide a user with enhanced message capabilities and attachment handling. These devices are specifically configured to provide contact and message applications over a wireless network.

When the phone is lost, a user's information may be subject to use by others.

### SUMMARY

In one aspect, the technology provides a mechanism to secure personal information stored on a wireless device after the device is lost or stolen by encrypting or destroying the information. In one embodiment, the invention includes a method for securing a mobile device having an information store. The method includes the steps of providing a mobile device application on a mobile device; and signaling the mobile application instructing the mobile application to render any user information stored on the mobile device useless.

In an alternative embodiment, a method for securing personal information on a mobile device includes receiving an signal from a user to render personal information stored on the mobile device useless; and upon receipt of said signal, interacting with said user information to render at least a portion of the personal information inaccessible on the mobile device.

In a further aspect, the invention is a method for providing an information service implemented on one or more processing devices coupled to a communication network. The information service includes storing personal information for a plurality of users; providing a mobile device application to one or more users, the application including an information purge function enabled by a signal from the information service; upon installation of the mobile device application, receiving a set of configuration data for the mobile application from at least one user; and upon receiving an instruction from the at least one user to enable the information purge function, outputting a signal to the mobile application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system suitable for implementing the identification system of present invention.

FIGS. 2 and 3 are block diagrams of methods of the present invention.

### DETAILED DESCRIPTION

The present invention allows the automatic destruction of personal information of a user stored on a phone or other mobile device via a remote signal. A user can configure a remote activated destruction sequence on the phone via a number of mechanisms.

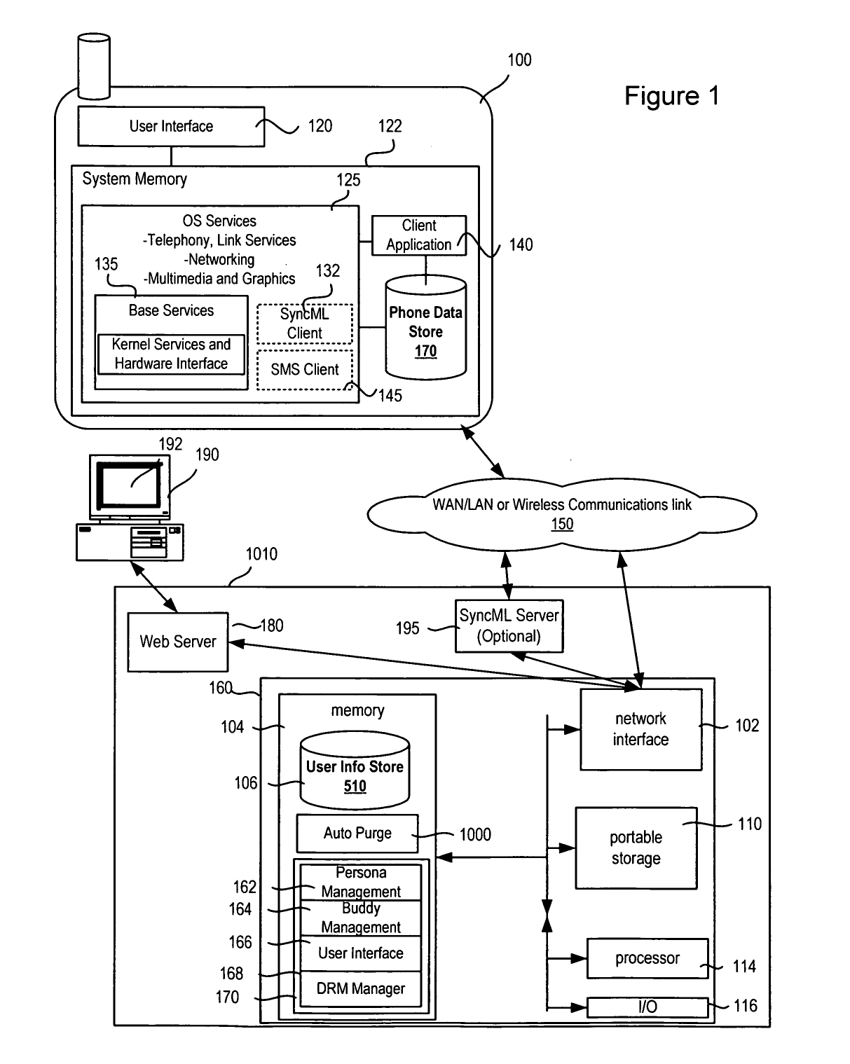

FIG. 1 illustrates a general overview of a system for implementing the present invention. As shown in FIG. 1, a wireless communication device, such as a phone 100, is connected to a wireless communications link, such as a cellular network 150, to transmit voice and data communications to other devices coupling to the wireless network. It will be understood that the wireless link may be a wireless internet link or a cellular network maintained by a cellular carrier, a GSM or CDMA network, or some other wireless communications link. The carrier may comprise the enterprise service provider or may be separate from the enterprise service provider. Data may be transmitted over the network in any number of known formats.

Also shown in FIG. 1 is a communications enterprise service 1010 which may include an advanced ID server 160, Web Server 180 and SyncML Server 195. An advanced ID server 160 communicates with the phone 100 via wireless network 150 directly over a data connection or via a SyncML server 195. Various embodiments of a system for implementing the advanced ID service are discussed herein. In FIG. 1, the ID server 160 communicates directly with the phone 100. In alternative embodiments, discussed below, the ID system is implemented on top of a synchronization system such as that described in U.S. Pat. Nos. 6,671,757, 6,694,336 or 6,757,696 and communicates with phone 100 via that synchronization system.

Phone 100 may be provided with a system application or agent 140. System agent 140 can include a SyncML communication client designed to interact with a SyncML server 195 in accordance with approved and proposed versions of the SyncML OMA DS specification, including proposed extensions, (available at http://www.openmobilealliance.org). Alternatively, agent 140 can be an application designed to communicate with server 160 using an existing SyncML client on the phone provided by the phone's manufacturer (as well as any custom extensions supported by such client), or an application specifically designed to communicate with server 160 via another protocol, including a proprietary protocol. In one embodiment, the agent 140 is a fully implemented SyncML client and server 160 includes a SyncML server. In another embodiment, the application 140 is a client application device sync agent such as that disclosed in U.S. Pat. No. 6,671,757. Various embodiments of the client application 140 are set forth below.

In accordance with the present invention, a phone 100 includes a system memory 122 which may further include an operating system 124 having operating system services including telephony and linking services, networking services, multimedia and graphics display services all provided to a user interface 120. System memory 122 includes both volatile and non-volatile memory components OS services and running application are provided in volatile memory, while data store 170 is provided in non-volatile system memory. OS 125 my be the phone's proprietary OS, BREW, or any other device or operating system suitable for a phone (such as the Symbian Operating system). Additional base services 135 and an operating system kernel may also be provided. The operating system may additionally provide an SMS client 145 built into the operating system allowing short messages to be provided across the wireless communications line 150 to other users. Still further, a SyncML client 132 may be provided and supported by the operating system services 124. The phone 100 includes a native phone data store 170 which contains address book contact and other information which may be provided by a subscriber. Such information can further include ringtones, pictures, sounds, and movies, all dependent on the functional capabilities of the phone 100, the space allowed in the system memory, and the services provided by the operating system 124.

The system agent 140, various embodiments of which are discussed herein, is loaded into memory 122 of phone 100. As will be well understood by one of average skill in the art, agent 140 can be provided by the phone manufacturer or downloaded by a user at a later time. To download and install the application, the user selects a download area of the phone operating system services 124, selects the application from offerings provided by the service provider or carrier who maintains the wireless communications line 150, or an enterprise service provider who maintains the system server 160, and installs the application onto phone 100. In an alternative embodiment, agent 140 is a self-supporting application designed to run as a JAVA or BREW agent, or any other device or operating system specific agent (such as an agent operable on the Symbian Operating system). This agent can either include its own SyncML client, or interact with an existing SyncML client on the telephone. Alternative embodiments can communicate via alternative protocols via the wireless communications link to store information on the System data base 510.

Client 100 includes at least a user interface 120, the application 140 having a communication or sync engine and data store manager, a SyncML client 132 and a local database 150. The client application 140 provides an appropriate application user interface to the phone's UI 120 which provides the user an alternative point of interaction with the system and service provided by the enterprise service provider. The application user interface allows the user to define and manage personas and buddies as well as other tasks as specified in the case definition described herein. Interaction with the system can be via this client user interface or via the server user interface provided by the web server 180. The engine and data store manager is responsible for maintaining the user settings and options in the device's persistent storage as well as automatically pushing and retrieving changes to those object to the system server. The client datastore includes account information, persona data, buddy information, data for other users who have true links with the subscriber, and multimedia content

The storage server 160 is a centralized storage location for all system service information, including buddy, persona, relationship, and user data. Clients 140 can connect to and synchronized with the server information to update their local copy of this data as well as publish any changed information or retrieve any new available information from the server. In the mobile device, the persona information belonging to a user's buddy is primarily stored in the native address book or a separate address book provided by the client. As some devices will not support all the published buddy information including the extended information such as geo location and presence information, the client can store this information in a local database and provide access to it via the phone interface.

In general, a hardware structure suitable for implementing server 160, webserver 180 or SyncML server 195 includes a processor 114, memory 104, nonvolatile storage device 106, portable storage device 110, network interface 112 and I/O device(s) 116. The choice of processor is not critical as long as a suitable processor with sufficient speed is chosen. Memory 104 could be any conventional computer memory known in the art. Nonvolatile storage device 106 could include a hard drive, CDROM, CDRW, flash memory card, or any other nonvolatile storage device. Portable storage 108 could include a floppy disk drive or another portable storage device. The computing system may include one or more network interfaces 102. An example of a network interface includes a network card connected to an Ethernet or other type of LAN. I/O device(s) 116 can include one or more of the following: keyboard, mouse, monitor, display, printer, modem, etc. Software used to perform the methods of the present invention are likely to be stored in memory 104 which include nonvolatile storage and volatile memory as well as, portable storage media 110.

The computing system also includes a database 106. In alternative embodiments, database 106 is stored in memory 104, portable storage 110 or another storage device that is part of the system of FIG. 1 or is in communication with the system of FIG. 1. Other alternative architectures can also be used that are different from that depicted in FIG. 1. Various embodiments, versions and modifications of systems of FIG. 1 can be used to implement a computing device that performs all or part of the present invention. Examples of suitable computing devices include a personal computer, computer workstation, mainframe computer, handheld computer, personal digital assistant, pager, cellular telephone, smart appliance or multiple computers, a storage area network, a server farm, or any other suitable computing device. There may be any number of servers 160n, n+1 managed by a system administrator providing a back up service in accordance with the present invention.

Also provided on server 160 is a system data store 310. The data store is provided in the non-volatile memory space of server 160. While only one data store 160 is shown, it should be recognized that the store 160 may be replicated to or stored over a plurality of computers to ensure that the data thereon is protected from accidental loss. It should be understood that the representation of the SyncML server 195 and web sever 180 need not require that such servers be provided on different physical hardware than the System server 160.

The system of FIG. 1 illustrates one server and client system suitable for use in the present invention. In an alternative embodiment of the invention, the advanced ID system can be constructed using a synchronization server described in U.S. Pat. Nos. 6,671,757, 6,694,336 or 6,757,696.

A synchronization system described with respect to U.S. Pat. Nos. 6,671,757, 6,694,336 or 6,757,696 comprises client software which provides the functions of a differencing transmitter/receiver/engine, and differencing synchronizer in the form of a device engine. The device engine may include at least one component particular to the type of device on which the device engine runs, which enables extraction of information from the device and conversion of the information to difference information, and transmission of the difference information to the storage server. The storage servers utilized in the may be any type of storage server, such as an Internet server or an FTP server, and may be provided from any source, such as any Internet service provider. In a key aspect of the sync system, the Internet connection between the devices or between the devices and a server, need not exist at the same point in time. In addition, only those changes to the information which are required to be forwarded to other systems on the system of the present invention are transmitted to enable fast response times.

Data from each of the sync client devices is coupled with a storage server. In one embodiment, each device engine implements all processing required to keep all the systems fully synchronized. Only one device engine needs to be coupled to the sync server at one particular point in time. This permits synchronization of multiple systems in a disconnected fashion. Each device engine will download all transactions encapsulating changes that have occurred since the last synchronization from the server and apply them to the particular device. The change or difference information (termed a “data package” or “change log”) is provided in one or more data packages. Each data package describes changes to any and all transfer information across all device engines, including but not limited to application data, files, folders, application settings, and the like. Each device engine can control the download of data packages that include classes of information that apply to the specified local device. For example, contact names and phone numbers while another needs only changes to e-mail, changes to document files.

Compression and encryption of the data packages may be optionally provided. Each device engine performs mapping and translation steps necessary for applying the data packages to the local format required for that type of information in the application data stores. The device engine also includes components which allow it to track ambiguous updates in cases where users have changed data to a particular data field on two different systems simultaneously since the last update. The output of the device engine comprises a data package which is output to sync server database. As noted above, only one device engine need be connected to the storage server 850 at a given time. The data package can be stored on the storage server until a request is made to a particular location of the storage server by another device engine. Access to areas of the storage server is controlled by a management server (MS). In one embodiment, each sync operation requires that the device engine for each device login to the management server to authenticate the device and provide the device engine with the location of the individual device's data packages on the storage server.

When data is returned to the delta module from the storage server, the delta module returns differenced data to the application object for the particular application which then translates the delta information into the particular interface utilized for application. Once a device engine has been fully applied all data packages from an input stream, it generates a series of data packages that describe the changes made on the local system. The device engine uses the local application objects to keep track of the last synchronized version of each application's actual data, which is then used for the next data comparison by the delta module on the next sync request. Generated data packages can include operations and encode changes generated from resolving ambiguous cases as described above.

In this implementation, the sync server uses the concept of a universal data record in its internal sync differencing engine and when sending data to and retrieving from external

The management server supports an authentication interface that requires each device engine to authenticate with the management server before performing synchronization. Certain storage server implementations may utilize locking semantics to control read and write access to storage for multiple device engines. For example, in a generic FTP request, if two device engines attempt to connect to the same data at the same time, there must be some form of locking control to prevent device engines accessing the same data at the same time. In this instance, the management server controls the device engine acquisition, renewal, and releasing of locks against data stored in the network.

Each device engine is uniquely identified and tracked by the management server. This allows for tailoring behavior between the management server and specific types of storage systems and device engine components. All device engine components are tagged and version stamped for management via the management server.

Also shown in FIG. 1 is a server-side application ID service controller application 170 which includes a persona management component 162, a buddy management component 164, a user interface 166, and a digital rights manager 168. It will be understood in various implementations of the present invention, the functional components operating within the service-side application 170 can come in one case, push information maintained by the system of the present invention directly into phone 100 via a SyncML server 195 interacting with a fully robust SyncML client. Optionally, certain aspects of the control are handled by either the server-side application 170 or the client-side application 140, as described herein.

In accordance with the invention, application agent 140 communicates personification information and changes made to the personification information stored in the data store of the telephone 100 to server 160 via the wireless network. Communication of user data from the device may take several forms. Where the client utilized SyncML communications with the server 160, communication may take place using the standards set forth in the SyncML specification. Changes are transmitted on a record-by-record basis or field-by-field basis. Alternatively, communication may occur via another protocol. The SyncML client is utilized to update the phone's native address book with buddy published information as well as to retrieve persona and link information from the server. Information can be exchanged via the SyncML protocol, or via a direct data link with the server 160. The system server stores and maintains each user account, link personal and buddy information as well as multimedia content, both system provided and user created. The server is a stand alone server and may be incorporated with the features of a synchronization system such as that described in U.S. Pat. No. 6,671,757. Details of this integration are described in further detail below. As noted above, a management interface is provided via the web server 180. Description of this interface is shown below.

The server 160 stores backup user data in a backup store 510 in a manner which associates the data with the user of the phone. In one embodiment the data is stored in bulk—that is all records and information for the user are stored in simple text form, or a copy of the entire database from the phone is stored on the server. In this embodiment, the server may store any number of copies of the data on a date-identified basis. Alternatively, the server 160 translates this information into change logs, in one embodiment, in accordance with the teachings of U.S. Pat. No. 6,671,757, 6,694,336 or 6,757,696. This information is stored in backup data store 510 on server 160. This information is stored in the data store using a unique identifier (UID) associating the data with the individual user. The identifier may be any randomly selected identifier, so long as the user is uniquely identified, and the data is associated with the user. In a further aspect, this user UID may be a universally unique identifier (UUID), created in a manner described in the aforementioned U.S. Pat. No. 6,671,757, 6,694,336 or 6,757,696 patents or other manners to create a single ID for a given user.

Data store 510 can be any form of data storage for the user data. In one embodiment, the data store is a simple copy of the information stored on the device 100. In another embodiment, the data store is a database, such as an object database or a relational database. In yet another embodiment, the data store is simply a storage container for change logs created in accordance with U.S. Pat. No. 6,671,757.

A web server 180 allowing a user on a computer or other device 190 having a web browser may optionally be provided to allow a user to configure aspects of the system of the invention. Server 180 may have a hardware configuration similar to computer 160 and may comprise one or more physical computers. Additionally, web server 180 may be integrated with server 160.

In one embodiment, aspects of the system of the present invention are configured via a phone interface. The system can alternatively be configured by a user via a web interface provided by the web server 180 via the user device 190.

In a unique aspect, the technology provides an auto-purge function for information stored in the data store 170 of the mobile device. The purpose of auto-purge is to ensure the privacy of a users' personal information on their mobile device in the event the device is lost, stolen, or otherwise compromised. Auto-purge deletes (or scrambles) the user's personal information contained in their address book, calendar, task list, photo gallery, downloaded media, and other on-device data stores. In addition, auto-purge may remove passwords, application settings, device configuration information, and other data present in volatile or non-volatile system memory 122, depending on a configuration defined by the user or the auto-purge system. In one embodiment, auto-purge may render the device inoperable by disabling the device's operating system, access points, network identification, BIOS, or other system software. In another embodiment, the device may silently relay its GPS position to the server when it receives an auto-purge command.

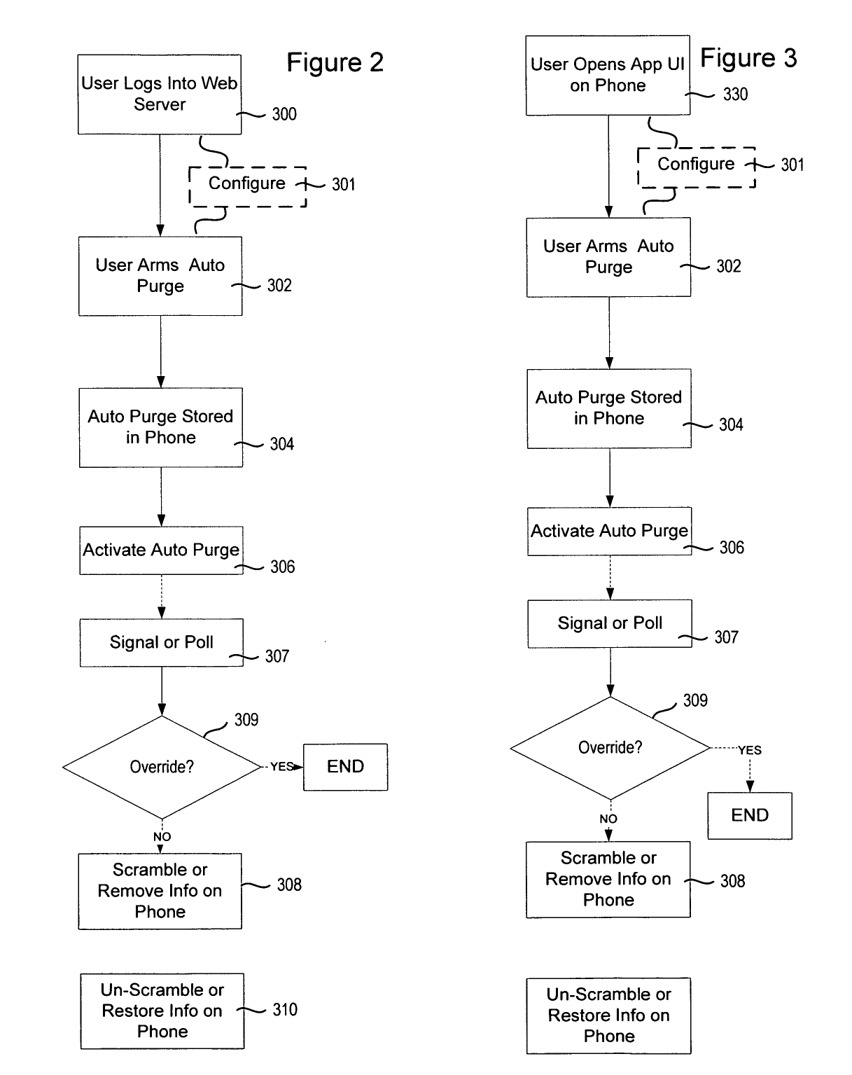

Shown in FIG. 1 is an auto-purge engine 1000 running in memory of server 60. In one embodiment, client application 140 and engine 1000 cooperate to enable an automatic purge of any user information stored in the phone data store 170 and a memory 140. In another embodiment, the auto-purge function is performed entirely by the client application 140. Typically, a user's phone data store may include phone numbers and information that the user would prefer not be accessible to other should the phone be lost or stolen. The method of FIG. 2 accomplishes a scramble or remove purging process.

At step 300, a user logs into the web server 180 to configure the auto purge process. Optionally, the auto-purge process may be enabled via the device 100. Next, at step 301, the auto-purge service may be configured. Configuration of auto-purge may be done on the mobile device 100 via auto-purge in client 140, via a web interface 180, via a program installed on a personal computer, via a telephony server (e.g., user can make a voice call to a server and use key tones to enter their authentication information), or via some other interface capable of accepting user input and relaying that input to the auto-purge server. Configuration options include an auto-purge password, an override code, and specification of which applications, settings, datastores, or other data are subject to auto-purge. Optionally, the user may select different codes and settings on a per-application, per-setting, per-datastore, or per-object basis. Alternatively, the user may use a single “Master auto-purge” setting which will remove or scramble all information possible from the device 100. Users may select the level of purge for such a “Master auto-purge” configruation (e.g., only remove the address book data, passwords, etc—but leave the device functioning). Configuration 301 is optional; in one embodiment, the user may simply enable the auto-purge functions and be provided with standard, pre-configured service.

Once the device's auto-purge settings are finalized, auto-purge is “armed” for that device at step 302. Auto-purge is then enabled in the client application at step 304. An auto-purge password and override setting may be stored on the device at step 304 in an obfuscated or encrypted form, or they may be stored only on the server 160. Note that the over-ride function is optional.

Generally, at a later point in time, (as indicated by the dashed line between step 304 and 306) when the user wishes to purge information on the device 100, the user activates the auto-purge feature at 306 by relaying a command to the server 160 by accessing the enterprise service 1010 via one of the mechanisms described above. Optionally, the user may send a signal directly to the application from another mobile device or processing device. The server 160 at step 307, relays an auto-purge command to the device via a mechanism such as a specially formatted SMS, a direct socket connection, or a specially formatted email. Alternatively, the device 100 may poll the server at an interval to determine if any auto-purge command is pending for the device. Upon receipt of a valid auto-purge command, if there is a configured override code, at step 309 the user may be prompted to enter the override code. This allows the user to prevent the auto-purge if they regain control of the device after sending the auto-purge command. If the user does not successfully enter the override code (optionally, after a number of retries), the auto-purge will take place at step 308. Optionally, the device may notify the server that the override code was entered successfully. In such an embodiment, the server will not resend auto-purge commands to the device if the code has been entered successfully. Without an override code—or upon receiving a signal which indicates the device should ignore any configured override code—the device will automatically delete or scramble data without user notification or intervention.

In a further optional step 310, the user information may be recovered or restored at step 310. If the user information is encrypted or deleted, the information may be loaded into the device from the data store 510 on server 1010. Alternatively, encrypted information still resident on the phone may be decrypted by a decrypt command, by providing an appropriate decryption key, or by entering a password (or restore code) to application 140 directly or from server 1010 once the device is recovered.

If the device receives multiple auto-purge commands, it may keep track of the number received and auto-purge without user intervention after a certain number of valid auto-purge commands have been reached (this will prevent an attacker from repeatedly power-cycling the device upon receipt of an auto-purge command). In another embodiment, once a valid auto-purge command has been received, on the next (and subsequent) restarts of the device, the auto-purge application will take control of the device's UI and require the entry of the override command.

In another embodiment, different auto-purge codes may be configured by the user for different functions on the purge features. For example, a user may configure a first code to delete information and a second to scramble information on the phone with a reversible encryption technique. This is useful where a user is unsure whether they have lost the phone or whether it has been stolen. These signals may be used in conjunction, such that scrambled data may later be deleted; “unscramble38 code may also be configured.

To prevent malicious attackers from sending auto-purge commands to devices, standard public key encryption techniques may be used to verify the identity of the command initiator (similarly to how SSL clients verify the SSL server's certificate is valid). In this case, the client may be configured with the server's certificate at the time the auto-purge application is installed on the device. Alternatively, the server may transmit an auto-purge password (or password proxy such as a nonce/digest pair) in the auto-purge message. That will allow the device to validate the authenticity of the auto-purge command.

Scrambling of data may be accomplished by overwriting records, settings, files, or data structures on the device with randomly generated data, a data pattern (such as all 0's or 1's).

FIG. 3 illustrates an alternative embodiment of the technology wherein the auto purge function is enabled by application 140 entirely on phone 100. As shown therein, at step 330, the user accesses an appropriate user interface provided by application 140 on phone UI 120. Configuration options such as those discussed above are provided by the interface and the application optionally configured (step 301) and armed (step 302) in accordance with the description of the method of FIG. 2. As noted above, the signal to activate the auto purge at step 306 may be provided by server 1010 or another wireless device directly to the device 100.

The foregoing detailed description of the invention has been presented for purposes of illustration and description. It is not intended to be exhaustive or to limit the invention to the precise form disclosed. Many modifications and variations are possible in light of the above teaching. As noted herein, numerous variations on the architecture of the present invention are possible without departing from the scope and content of the present invention. In one embodiment, requests and responses can be compressed and encrypted.

The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for securing a mobile device having an information store, comprising:
providing a mobile device application on a mobile device; and
signaling the mobile application instructing the mobile application to render any user information stored on the mobile device useless.

2. The method of claim I wherein the step of signaling is performed by an enterprise service provider.

3. The method of claim 1 wherein the user information is rendered useless on the mobile device without providing any indication to a user interface on the device that the rendering is to occur.

4. The method of claim 1 further including the step of storing a copy of the personal information.

5. The method of claim 1 further including the step of restoring a copy of the personal information upon receipt of a restore command from the user.

6. The method of claim 1 wherein the step of signaling includes sending the signal from another mobile device.

7. The method of claim 1 wherein the step of instructing includes instructing the device to encrypt the personal information.

8. The method of claim 7 wherein the step of instructing includes instructing the device to decrypt the personal information.

9. The method of claim 1 wherein the step of instructing includes instructing the device to delete the personal information.

10. The method of claim 1 wherein the mobile device is a phone.

11. The method of claim 1 wherein the mobile device includes one or more sets of personal information for the user.

12. The method of claim 11 wherein the instructing step includes instructing the application to render a subset of the personal information useless.

13. A method for securing personal information on a mobile device, comprising:
receiving an signal from a user to render personal information stored on the mobile device useless; and
upon receipt of said signal, interacting with said user information to render at least a portion of the personal information inaccessible on the mobile device.

14. The method of claim 13 wherein the step of receiving includes receiving the signal from enterprise service provider.

15. The method of claim 13 wherein the signal is provided by the enterprise service provided when the user requests that the enterprise service provider send the signal

16. The method of claim 13 wherein the step of receiving includes receiving the signal from another mobile device.

17. The method of claim 13 wherein the step of interacting includes scrambling the personal information.

18. The method of claim 13 wherein the step of interacting includes deleting the personal information.

19. The method of claim 13 wherein the mobile device is a phone.

20. The method of claim 13 wherein the mobile device includes one or more sets of personal information for the user.

21. The method of claim 20 wherein the interacting step includes acting on only a subset of the user information.

22. The method of claim 13 wherein the step of interacting includes acting on all of the personal information

23. The method of claim 13 wherein the method further includes providing a mobile application to perform said receiving and interacting steps.

24. A method for providing an information service implemented on one or more processing devices coupled to a communication network, comprising:
storing personal information for a plurality of users;
providing a mobile device application to one or more users, the application including an information purge function enabled by a signal from the information service;
upon installation of the mobile device application, receiving a set of configuration data for the mobile application from at least one user; and
upon receiving an instruction from the at least one user to enable the information purge function, outputting a purge signal to the mobile application.

25. The method of claim 24 further including the step of providing a copy of the personal information upon receipt of a restore command from the user.

26. The method of claim 24 wherein the step of receiving includes receiving an instruction from another mobile device.

27. The method of claim 24 wherein the step of outputting a signal includes outputting a signal to the application to encrypt the personal information.

28. The method of claim 1 wherein the step of outputting a signal includes outputting a signal to the application to decrypt the personal information.

29. The method of claim 1 wherein the step of outputting a signal includes outputting a signal to the application to delete the personal information.
